(19) United States
(12) Patent Application Publication
(10) Pub. No.: US 2017/0206854 A1
(43) Pub. Date: Jul. 20, 2017

(54) DEVICE AND METHOD FOR DISPLAYING INFORMATION ON A SCREEN ARRANGEMENT HAVING A PLURALITY OF INDIVIDUAL SCREEN MODULES

(71) Applicant: Display Solution AG, Gilching (DE)

(72) Inventor: Norbert Erhart, München (DE)

(73) Assignee: Display Solution AG, Gilching (DE)

(21) Appl. No.: 15/327,650

(22) PCT Filed: Jul. 21, 2015
(86) PCT No.: PCT/EP2015/066628

§ 371 Date: Jan. 19, 2017

(30) Foreign Application Priority Data
Jul. 21, 2014 (DE) 10 2014 010 780.9

(51) Int. Cl. G09G 5/00; G09G 5/391; G06F 3/14

(52) U.S. Cl. CPC G09G 5/006; G06F 3/1446; G06F 3/1431; G09G 5/391; G09G 2340/0407; G09G 2300/026

(57) ABSTRACT

A description is given of a device and a method for displaying information compiled in the form of a so-called image format (13), more particularly product- and/or advertising-specific information contents, on a screen arrangement having a plurality of individual screen modules (11). A description is also given of a method for operating such a display device and of a method for generating the above-mentioned image format (13). The processing of the image format (13) to form so-called image partial formats (14) which correspond to the individual screen modules (11) is performed using a programmable logic IC technology. Preferably, the image partial formats (14) are communicated to individual screen modules (11) in parallel.

The present invention relates to an assembly and a method for displaying information which is compiled in the form of a so-called image format, more particularly of product- and/or advertisement-specific information contents, on a screen that comprises a plurality of individual screen modules. The invention additionally relates to a method for operating such a display assembly as well as to a method for generating the above mentioned image format.

As is known, it may, for example, be beneficial for the distribution of goods or services to present information with product- and/or service-specific contents in the vicinity of potential customers and/or advertised products or service locations. Such information may be information about products and/or services, including advertising contents, price quotations, notifications, or similar information. It is of particular advantage to present such information to a potential customer in a comprehensive manner and adjust such information to the particular information needs of said potential customer as quickly as possible.

To achieve this object, document RU2248609C2 proposes a method and an apparatus for displaying advertising information, wherein product-related information can be reproduced by means of a plurality of screens and loudspeakers which are arranged in the vicinity of advertised products or consumer groups, for example above the tills. The product-related information comes from a central control unit and is transferred to the screens and loudspeakers. The solution described in RU2248609C2 has the disadvantage that the screens must be controlled by so-called control servers in order to reproduce advertising contents by means of a plurality of screens and/or loudspeakers. In addition, the screen-loudspeaker units that are controlled by a single control server reproduce the same contents.

A further solution is offered in document DE69032016T2. This document describes a display system which is known as a so-called video wall and which can display images on a plurality of screens. The display system described in DE69032016T2includes a central computer as well as a direct access memory. The direct access memory is mapped into a plurality of memory slots which can be addressed by the central computer with each of these memory slots corresponding to a channel for a particular screen. Each channel comprises a screen driver which is connected to the memory and acts such that it provides a video signal to the respective screen. The central computer is able to write image data to each of the selected memory slots, and the screen drivers are able to simultaneously read the image data from the memory slots, in order to simultaneously deliver video signals to be displayed on the respective screens, wherein a part of the image is displayed on each screen, thereby displaying the complete image across this plurality of screens. Thus, the resolution of each screen of the display system is independent of the number of screens. Document DE69032016T2 emphasises as a particular advantage that the costs for generating graphics and text by means of the computer are very low as compared with the costs incurred when having to take a video, and that this considerably increases number of the possible applications of video walls. This eliminates the necessity to provide a video that has been taken beforehand at each display location. Moreover, the use of a computer to generate graphics and text has the advantage that the information to be displayed can be easily updated.

An essential drawback of the solution described in DE69032016T2 is that, as is usual with video walls, only a larger image with its individual partial sections is represented on the individual screens, i.e., one image is enlarged to be shown on a plurality of screens. In addition, the structure of the display system according to DE69032016T2 is still very complicated and complex. For example, a central computer as well as additional screen drivers in the form of integrated circuits are required for each screen to allow implementing the display system. What is more, the range of applications of such video walls is relatively limited.

Another solution for a display assembly with a screen comprising a plurality of individual screen modules is described in document DE102011012173A1. This display assembly comprises control electronics for energising the screen modules, wherein the control electronics are formed to transmit an image format to the screen modules that consists of so-called partial formats. In order to handle the display of the individual partial formats by means of the respective screen modules, each screen module is equipped with selection electronics. DE102011012173A1 emphasizes that an advantage of this solution is that it is no longer necessary to address the individual screen modules by the control electronics because the selection electronics automatically determine at each screen module the partial format to be displayed from the complete image format data stream transmitted by the control electronics. The solution known from DE102011012173A1 has the disadvantage that the price of the display assembly is increased by the fact that selection electronics are required at each screen module.

It is therefore the object of the present invention to eliminate the disadvantages of the known prior art display assemblies without affecting the performance and the versatility of display assemblies. What is more, a further object of this invention—in synergy with the aforementioned objects—is to additionally reduce the costs as compared with the known display systems comprising a plurality of screen modules.

This object is achieved by means of a display assembly according to Claim 1, a method for operating such an assembly according to Claim 12, a method for displaying an image format according to Claim 13, and a method for generating an image format according to Claim 15. The dependent claims describe preferred exemplary embodiments of the present invention.

The invention discloses a display assembly with a screen comprising a plurality of individual screen modules, with control electronics for energising screen modules, wherein the control electronics are formed to transmit an image format corresponding to the display of the screen, wherein the image format comprises a plurality of image formats corresponding to the display of individual screen modules. According to the invention, the control electronics are designed with use being made of programmable logic IC technology. Hereafter, the abbreviated term IC means an integrated circuit. The use according to the invention of programmable logic circuits allows a considerable reduction of system costs while maintaining the performance of the display assembly as well as the versatility of its possible applications.

By way of example, a possible programmable logic IC technology may be a field programmable gate array (FPGA) technology, a complex programmable logic device (CPLD) technology or a system-on-a-chip (SoC) technology, wherein preference is given to the FPGA technology. Through the use of the programmable logic IC technology in display assemblies and methods according to the invention, it is possible to do without conventional software-controlled solutions that are based on computers or processors (CPUs) to the greatest possible extent or even completely.

In digital technology, the term field programmable gate array or its abbreviation FPGA describes an integrated circuit (IC) in which a logic circuit can be programmed. Hence, an FPGA is a digital integrated circuit which can be programmed and/or configured by the customer and which consists of a plurality of interconnectable functional units.

In contrast to the programming of usual computers, servers or similar control units, the term program relates to the specification of time flows in the FPGA module in a subordinate manner only. Primarily, FPGA programming is directed to the definition of the functional structure of the FPGA module. Initially, the programming of structural rules determines the basic functional principle of individual universal blocks in the FPGA and their interconnection. This is also referred to as the configuration of an FPGA.

Often, FPGAs are used synonymously or are compared with the digital and likewise (re)configurable CPLD (complex programmable logic devices) modules. An essential difference between FPGAs and CPLDs is that the CPLDs are considerably simpler in their structure than FPGAs. In particular, CPLDs do not have a fine-meshed array (field) of logic blocks and so-called flip-flops but only a configurable switching matrix that can connect different input signals to obtain different output signals. Since they are simpler in their structure than FPGAs or SoCs, however, CPLDs are considerably more economical in their current consumption and sometimes have a shorter reaction time as well.

According to the present invention, it is particularly advantageous that modules or integrated circuits (ICs) of the programmable logic IC technology, for example FPGAs, have a logic complexity or integration degree ranging from 1,200 to 2,000,000 so-called gate equivalents. Usually, gate equivalents are referred to as the number of gates which would be necessary to realize a certain circuit. Programmable logic IC modules having this logic complexity facilitate simultaneous or cumulative optimisation of the performance of such logic IC modules for the purpose mentioned herein, i.e., the energisation of a display assembly with a screen comprising a plurality of individual screen modules, as well as of the time and effort required for programming such logic IC modules in addition to the acquisition costs for such logic IC modules.

It is of particular advantage when the logic complexity and/or the integration degree of modules of the programmable logic IC technology, e.g. FPGAs, are within a range from 1,200 to 150,000 gate equivalents for energising a display assembly according to the invention, when the incoming image format has a resolution of up to 1920×1080 pixels (full-high definition or full-HD) or up to 1920×1200 pixels (wide ultra extended graphics array or WUXGA). In order to process future applications having a resolution of the incoming image format of up to 3840×2160 pixels (quad-full-HD) or 4096×2160 pixels (ultra high definition), it is also possible to use programmable logic IC modules having a logic complexity of up to 2,000,000 gate equivalents.

It is of particular advantage that the total number of inputs/outputs (I/Os) or pins in a programmable logic IC module, e.g., in an FPGA, can range from 40 to 500 to facilitate direct energisation of screen modules by means of the control electronics. The exact number of the I/O pins required on the programmable logic IC module depends on the composition of the interface of the screen module. For TTL or LVTTL interfaces, it is, for example, advantageous—depending on the colour depth required—to use 3 to 30 I/O pins for the RGB colour space and—depending on the display type—2 to 6 I/O pins for control signals. For an LVDS interface, it is advantageous to use 2 to 10 so-called pairs, i.e., 4 to 20 I/O pins.

According to the present invention, the control electronics based on programmable logic IC technology is preferably configured using the hardware description language (HDL), more particularly a very high speed integrated circuit hardware description language (VHDL) or a Verilog language, whereby the configuration of the control electronics is considerably simplified and accelerated.

It is particularly preferred that at least a part of the partial image formats should be transmitted to individual screen modules in parallel, i.e., through lines that are laid in parallel from the control electronics to the individual screen modules. For such parallel transmission to individual screen modules or for such parallel energisation of individual screen modules by means of control electronics, it is, however, possible to use various interfaces, e.g., a low voltage differential signaling (LVDS) and/or transistor-transistor logic (TTL) or low voltage transistor-transistor logic (LVTTL) interface. This procedure has the particular advantage that the individual screen modules of the display assembly are directly addressed or energised by the control electronics, whereby the use of selection electronics in each screen module is prevented. In addition, parallel transmission of the partial image formats to the individual screen modules also means less synchronisation efforts, in particular when the screen consisting of a plurality of screen modules is used for reproducing moving pictures which extend across a plurality of screen modules.

It must be noted that the term screen in the sense of the present invention is not understood to mean that the screen modules must by necessity be arranged next to each other and/or one below the other, as is the case, for example, with video walls. On the contrary, individual screen modules can be arranged according to the customers' or products' and service providers' needs. For example, individual screen modules can be arranged in a retail shelf directly underneath offered products, therein fulfilling both the function of a price label and of an information and/or advertising panel. Other possible deployments and attachments of individual screen modules are also conceivable.

It is further preferred that the control electronics should transmit a partial image format to a screen module in digital form. In most cases, digital data transmission results in quality advantages as compared with an analogue connection, such as by means of a VGA or SCART cable. In the transmission methods last mentioned, two signal conversions are required (which are not necessary for digital screens), i.e., from digital to analogue at the video output and from analogue to digital in the monitor. Accordingly, running times have a strong effect on electronics. The individual pixels of the partial image format and the image format can be represented as 18-, 24- and/or 32-bit data words, whereby an adequate colour depth can be achieved for transmitting the video signals to be displayed.

In a further preferred embodiment of the present invention, partial image formats are transmitted to individual screen modules through an low voltage differential signaling (LVDS) and/or transistor-transistor logic (TTL) or low voltage transistor-transistor logic (LVTTL) interface. While the TTL or LVTTL interface allows reliable data transmission over shorter distances between the control electronics of the display assembly and the screen modules, the LVDS interface can preferably be used for transmitting partial image formats over longer distances, in particular distances exceeding 1 meter. Frequently, however, the TTL or LVTTL interface is already integrated as a standard interface in cost-effective, more particularly small, screen modules. Therein, the control electronics can further comprise an inter-integrated circuit (I²C) and/or two-wire (TWI) interface, thereby allowing the transmission of additional control information.

In a preferred embodiment of the present invention, data of the image format are preferably transmitted to the control electronics via a digital visual (DVI) and/or transistor-transistor logic (TTL) interface, also using the transition minimized differential signaling (TMDS) technology. It is, however, also possible to use an USB (universal serial bus) interface, more particularly USB 2.0, USB 3.0, USB 3.1, etc.

According to the present invention, it is particularly preferred that at least one screen module of the screen of the display assembly is implemented as a so-called thin-film transistor (TFT) display because TFT display modules have an improved image quality, e.g., because of better addressing and contrast functions. In addition, TFT display modules are relatively low-priced, with the result that the costs for manufacturing the display assembly can be further optimised. Further, modern TFT display modules often already have an integrated interface for direct transmission of digital audio and/or video data as well as of control information from the control electronics, more particularly via a TTL or LVTTL and/or LVDS interface. However, this invention is not exclusively limited to the use of TFT display modules but can, for example, also be implemented on the basis of OLED and/or AMOLED display modules, etc.

As explained above, a screen module in the sense of the present invention preferably comprises a TTL, LVTTL and/or LVDS input interface. Generally, TTL, LVTTL and LVDS interfaces are not suitable for the output interfaces of commercially available computers, i.e., for the usual interfaces, such as VGA, DVI, HDMI or DisplayPort. Hence, the input interfaces of screen modules are different from the output interfaces of commercially available computers, such as VGA, DVI, HDMI or DisplayPort, not only in an electrical manner but also at a protocol level. In order to achieve an adjustment in these cases, complete control boards which usually only support certain display resolutions are required. Thus, the screen modules used in connection with the present invention, such as the TFT modules with lower resolutions that will be described below, are practically not supported by the output interfaces of commercially available computers or by the aforementioned additional control boards, with the result that a control by means of conventional standard technology is not possible at all. Implementation of the present invention therefore allows doing without the control boards that are typically used in commercially available computer monitors.

It must further be noted that TFT, OLED or AMOLED display modules which can be used as screen modules in the present invention have a specific resolution at horizontal and vertical pixels which must be energised exactly. In commercially available computer-monitor combinations, often the resolution issued by the computer does not match the so-called native resolution of the TFT, OLED or AMOLED display, i.e. the resolution which exactly corresponds to the physical digital resolution or number of pixels of a display assembly. In order to nevertheless facilitate control, the aforementioned control boards of commercially available computer monitors must additionally adjust or scale the size in a complex manner. The present invention has the advantage that such a scaling can be done without. Therefore, the resolution of the incoming image format can be selected such that it exactly corresponds to the total native resolution of the screen modules to be energised by the control electronics.

In the display assemblies according to the invention, such scaling may even be undesired, for example, when machine-readable code, e.g., bar codes, QR (quick response) codes or the like, which are embedded in the incoming image format must be reproduced. In such cases, it is essential that the respective black-and-white code patterns have sufficiently sharp black-and-white transitions. If the respective code pattern was scaled, the interpolated scaling would result in so-called “washed-out” transitions, i.e., transitions from black to white across a plurality of grey scales. This may also result in the code no longer being able to be machine-readable by the screen module.

It must be noted that, at present, display modules that are saleable on the market, such as TFT, OLED or AMOLED modules, mostly have a colour depth of 24 bits and special high-end display modules have a colour depth of up to 30 bits. These 24 or 30 bits, respectively, must be controlled precisely. Smaller display modules, such as are preferred herein, can be energised by the control electronics in parallel with 24 bits or 30 bits, respectively, corresponding to 24 or 30 lines. In addition to the colour information, the screen modules also require control signals. Depending on the screen module type, some or all of the following control signals are required, for example the so-called data clock, horizontal synchronization, vertical synchronization, display enable signal that marks the active part of each single line, the backlight activation signal, the signal for controlling the display brightness. According to the present invention, the colour depth can even be reduced to 1 bit, which is not possible with commercially available computer monitors or reasonable with typical applications. On the contrary, where commercially available computer monitors with higher resolutions and therefore higher frequencies are concerned, parallel data are first serialised as DVI or HDMI or DisplayPort signal and only then transmitted to the monitor, e.g., an LCD, TFT or OLED monitor.

In order to keep the costs of the display assembly on a moderate level, it is particularly preferred that the screen modules and/or the associated image formats have a resolution of up to 1024×600 pixels, wherein a resolution of 320×240, 400×240, 480×272, 480×320, 640×480, 800×480, 800×600 and/or 1024×600 pixels is particularly preferred.

All or some of the partial image formats and the associated screen modules can have the same resolution. The present invention, however, also allows variable subdivision of the partial image formats or the associated screen modules. With a resolution of the image format of 1920×1200 pixels, the display assembly according to the invention can, for example, be implemented either with 30 identical display modules having a resolution of 320×240 pixels or with 6 display modules having a resolution of 320×240 pixels, 6 display modules having a resolution of 480×320 pixels, and 3 display modules having a resolution of 640×480 pixels.

The control electronics of the display assembly according to the invention process the incoming image format to obtain individual partial image formats and transmit these to the corresponding screen modules, preferably in parallel. A partial image format is refined in the control electronics such that it corresponds to a reproduction on the respective screen module. In order to optimise the processing of the image format, the control electronics have an image memory, wherein the image memory preferably is operated in double buffering or triple buffering mode. This ensures that a complete partial image format for being output to the screen modules and therefore a continuous image frequency without any flickering are provided.

To intermediately store the screen content for further processing, use can be made of various memory types, such as SDRAM, DDR, DDR2, DDR3, etc. The preferred memory size depends on the resolution of the incoming image format and can be optimised depending on the type of buffering, i.e., multiple or single buffering. The memory band width required, i.e., the data volume that the memory can process or read and/or write during one time unit using its interface, depends on the resolution of the incoming image format and the selected refresh rate. For example, to represent video contents on the screen modules, refresh rates down to 24 Hz can be used in addition to the usual refresh rates of approx. 60 to 100 Hz for the incoming image format. As a result, the memory modules required can be optimised. If, however, it is intended to present static or quasi-static contents on the screen modules, the refresh rate for the incoming image format can be further reduced, e.g., to 1 Hz, i.e., 1 image per second, or even to a lower value, with the result that the memory bandwidth required can be further optimised. The present invention further allows increasing the presently preferably used colour depth of 24 bits to 30 bits on request or, in order to optimise the required memory size or memory band width, reducing said colour depth to 18 bits or even to a lower value.

The display assembly according to the invention can be used in manifold ways. It is, however, particularly advantageous to use it to reproduce product- and/or service-related information and/or to reproduce advertisements.

In a particularly preferred embodiment, at least a part of the screen modules can be implemented as interactive displays, thus, e.g., allowing bidirectional interaction with the customer. This interaction can be particularly achieved by means of so-called touch screens (touch-sensitive input modules) or by gesture control. In this case, individual screen modules are usually mounted in the immediate vicinity of offered products and/or services so that it is possible to transmit information to the customer which the customer currently needs. Product and/or service providers can also utilise this feature, for example, for goods inventory.

The present invention further relates to a method for operating a display assembly according to the invention.

Further, this invention discloses a method for displaying an image format in a display assembly with a screen comprising a plurality of individual screen modules, wherein data of the image format coming from an input source are processed in control electronics to obtain data of a plurality of partial image formats which correspond to the display of the individual screen modules. According to the invention, the processing of the data of the image format to obtain the data of the partial image formats is achieved in a programmable logic IC (integrated circuit) that is accordingly designed, more particularly in a field programmable gate array (FPGA), complex programmable logic device (CPLD) or system-on-a-chip (SoC) integrated circuit, with use being made of the hardware description language (HDL). The solution according to the invention allows more efficient processing of the partial image formats for their transfer to the screen modules by means of the control electronics, as well as reduction of the manufacturing costs.

Further, in a preferred embodiment of the display method according to the invention, the control electronics transmits at least a part of the partial image formats in parallel to the individual screen modules.

Finally, the present invention also relates to a method for generating an image format to be displayed in a display assembly according to the invention. In a particularly preferred embodiment, the image format the input source delivers to the control electronics, for example in the form of image and/or video contents, is composed of individual partial image formats such that the image format or the image and/or video contents can be reproduced on a plurality of screen modules in such a manner that the observer can perceive them as coherent image formats or image and/or video contents, wherein the individual screen modules do not necessarily have to be arranged side by side and/or one below the other. The advantages of this method become clearly visible particularly when moving pictures are reproduced on a plurality of screen modules.

Below, the present invention will be illustrated in more detail by means of examples shown in the figures. In the figures:

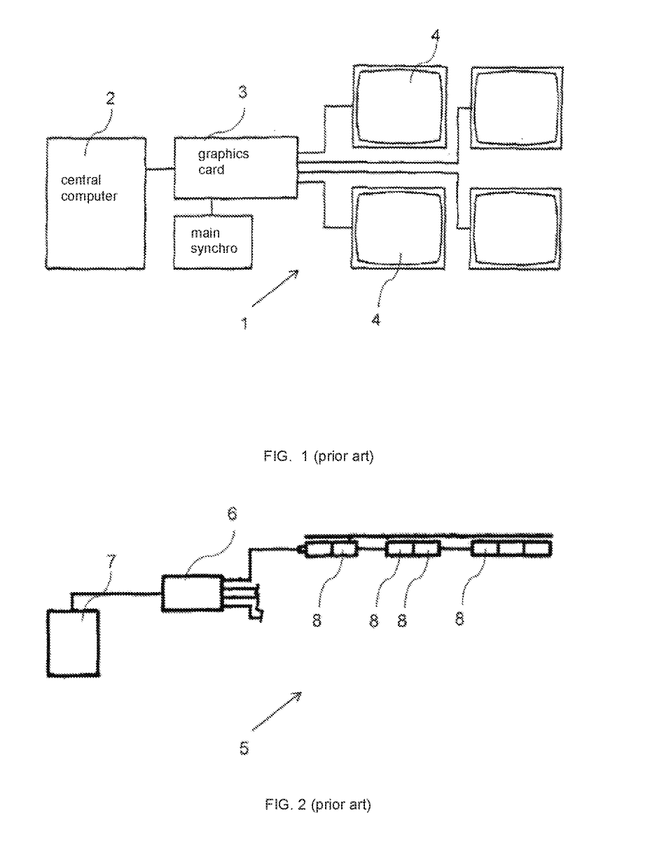

FIG. 1 shows a known prior art video wall;

FIG. 2 shows a known prior art display assembly with a screen comprising a plurality of screen modules;

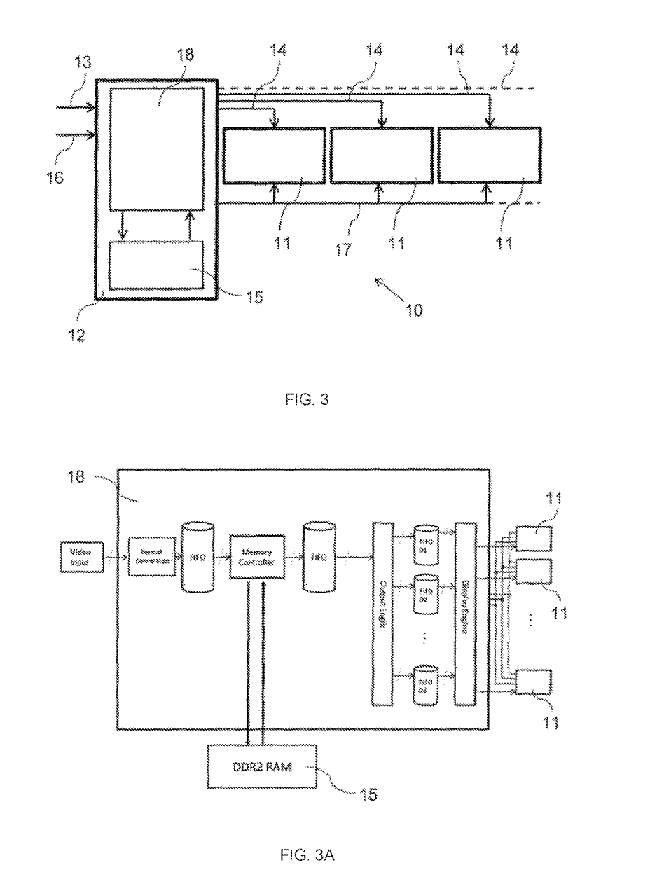

FIG. 3 shows a preferred embodiment of the display assembly according to the invention, and FIG. 3A shows a particularly preferred embodiment of a double-buffering mechanism for a display assembly according to the invention; and

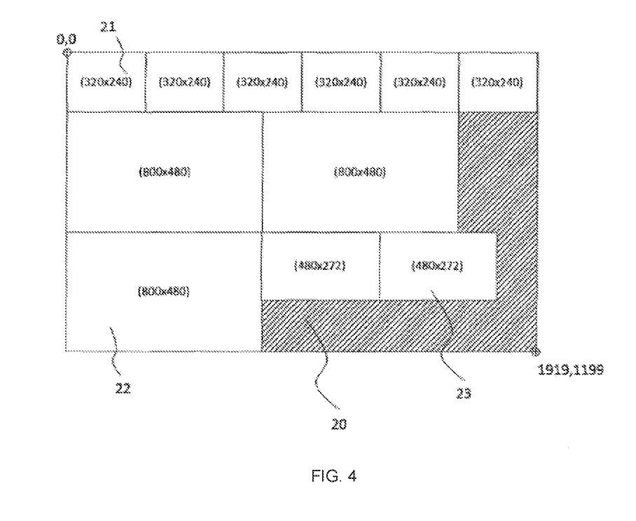

FIG. 4 shows an example of a subdivision of the image formats into individual partial image formats.

FIG. 1 shows a known prior art video wall 1 with a screen consisting of four screen modules 4. Therein, the screen modules 4 are connected to a central computer 2 via a graphics card 3, wherein the graphics card 3 can communicate with the central computer 2 via a computer bus. The central computer 2 is equipped with its own internal memory as well as hard disk and floppy disk drives and is used to generate graphics and text to be displayed. Among other elements, the graphics card 3 comprises a direct access memory that is subdivided into a plurality of memory slots as well as screen drivers. The central computer 2 writes the image data for the respective screen module to the memory slots. The screen drivers, i.e., commercially available integrated circuits, serve to read the image information from the respective memory slots pixel by pixel and to generate an image output signal along the lines running to the screen modules. The complex structure of the video wall 1 on the basis of IT-based technologies and graphics cards prevents the available resources from being utilised efficiently and, in addition, increases the development and production costs.

FIG. 2 shows a further solution approach for a display assembly 5 with a screen comprising a plurality of individual screen modules 8. The display assembly 5 comprises a transmission assembly 7 as well as, for example, control electronics 6 designed as a personal computer. These control electronics 6 serve to energise the screen modules 8, wherein the control electronics 6 are formed to transmit an image format to the screen modules that consists of so-called partial formats. In order to handle the display of the individual partial formats by means of the respective screen modules 8, each screen module 8 is equipped with selection electronics not shown in FIG. 2. The selection electronics can be programmed such that they select or filter the provided partial image format from the image format data selected by the control electronics 6 and supply said data to the display or screen module 8. A video decoder that can be preferably programmed to suit the respectively selected partial format to be represented and that can be arranged on a single microchip is suitable to be used as selection electronics. The use of the selection electronics not only raises the costs of manufacturing the display assembly 5 but also complicates the synchronisation of the individual partial image formats displayed on the screen modules 8.

The present invention not only solves the aforementioned cost-related problems but also simultaneously, i.e. synergistically, generates further advantageous effects, for example, a lower complexity in terms of synchronisation, improved utilisation of the resources available for processing image formats, etc.

Below, the present invention is illustrated in more detail by means of an example of FPGA-based programmable logic IC technology and TFT displays. It is, however, not limited to the FPGA and TFT technologies but can also be used, for example, in combination with CPLD, SoC, OLED or AMOLED technologies, etc.

In general, the so-called field programmable gate arrays or FPGAs are re-usable programmable silicon chips. Using prefabricated logic blocks and programmable routing resources, these chips can be configured such that they implement certain hardware functions without printed circuit boards or soldering irons being necessary. What is more, FPGAs can be completely reconfigured and can assume new properties once a different circuit configuration is implemented in such FPGAs. This implementation of a specific FPGA configuration usually requires profound knowledge in the field of digital hardware development.

Contrary to so-called application-specific integrated circuits (or ASICs), FPGAs provide hardware-synchronised speed and reliability with simultaneous cost efficiency. In contrast to usual processors, FPGAs offer genuine parallelism, with the result that different processing operations are not dependent on the same resource. Each single processing task is allocated to a dedicated area on the chip and can therefore be performed autonomously and without being affected by other logic blocks. For that reason, the performance of the application is not limited if other processing tasks are added.

FIG. 3 shows a preferred embodiment of the display assembly 10 according to the invention, with a screen comprising a plurality of individual screen modules 11 and with control electronics 12 for energising the screen modules 11. The control electronics 12 of the display assembly 10 are implemented using programmable logic IC technology. To achieve this, use is preferably made of a field programmable gate array (FPGA) 18; it is, however, also possible to use a complex programmable logic device (CPLD) or a system-on-a-chip (SoC). The control electronics 12 converts a digital video signal, for example, with a resolution of 1920×1200 pixels, at an input 13 into digital video signals at the outputs 14. Therein, the output 14 of the control electronics 12 is connected to the corresponding screen module 11 and is responsible for the transmission of a partial image format to the respective screen module 11. The data format at the outputs 14 is defined by the requirements of the screen modules 11. The partial image formats are transmitted in parallel to the respective screen modules 11, preferably using the low voltage differential signaling (LVDS) and/or transistor-transistor logic (TTL) format. The control electronics 12 in the above example with the image format having the resolution of 1920×1200 pixels can comprise 2 to 30 outputs 14 which are connected to 2 to 30 screen modules 11, respectively. Each partial image format can comprise different resolutions, with the result that a subdivision of the image format into partial image formats having the same size is not mandatory. The resolution of the partial image formats at the outputs 14 of the control electronics 12 determines the number and the resolution of the screen modules 11 in the display assembly 10. In a potential embodiment, at least a part of the screen modules 11 are implemented as interactive displays, thus allowing bidirectional interaction with the consumer, for example, by using so-called touch screens (touch-sensitive input modules) or gesture control.

The control electronics 12 according to the example shown in FIG. 3 comprises an FPGA 18 and a memory 15, which is, for example, operated in so-called double buffering or triple buffering mode. The memory 15 can be implemented as a so-called double data rate (DDR) memory. In addition to the input 13 provided to receive the digital video signal, the control electronics can also comprise an inter-integrated circuit (I²C) and/or a two-wire interface (TWI) 16, thus allowing bidirectional transmission of additional signals and control information to and from the display units, for example, for brightness control, sound, vitality monitoring, and user interaction. In this example, the FPGA 18 is responsible for processing partial image format data from the received digital video signal at the input 13 as well as for extracting control data from the interface 16. The control electronics 12 outputs the processed control data at the output 17 and transmits them to the individual screen modules 11.

FIG. 3A shows a detailed example for potential implementation of the double-buffering mechanism to be used with the display assembly according to the invention. Therein, the memory 15 is preferably implemented as a so-called DDR2RAM memory, wherein the control electronics 12 that are based on programmable logic IC technology are preferably equipped with a so-called first-in-first-out (FIFO) functionality. FIFO functionality is a method for storing data where the elements that were the first ones to be stored are also taken out of the memory first or output for further processing. Such a data structure is also referred as a (waiting) queue. However, the present invention is not exclusively limited to the DDR2 RAM memory and FIFO functionality.

The main task of the control electronics 12 that is made using the programmable logic IC technology and/or of the FPGA unit 18 is above all directed at distributing the digital image or video signal from the input 13 to the screen modules 11 in real time, and at generating the control signals required for the connected screen modules 11 to function properly, more particularly HSYNC and VSYNC synchronisation signals for horizontal and vertical synchronisation as well data enable (DE) synchronisation signals. It is not mandatory to completely distribute the image or video signal across all of the screen modules 11 of the display assembly 10 according to the invention; instead, the image or video signal can also be processed in part only to be reproduced on the screen modules 11, as shown in the exemplary embodiment according to FIG. 4.

FIG. 4 shows an example of a subdivision of the image format 20 into individual partial image formats 21, 22, 23. The present invention allows subdividing the image format 20 into partial image formats having different sizes and/or resolutions. For example, an image format having a resolution of 1920×1200 pixels can be subdivided into 6 partial image formats having a resolution of 320×240 pixels, 3 partial image formats having a resolution of 800×480 pixels, and 2 partial image formats having a resolution of 480×272 pixels. The total of 11 partial image formats thus processed are supplied to the outputs 14 by the control electronics 12 and subsequently transmitted for reproduction on the screen modules 11 with the corresponding resolution. However, the invention is not limited to the subdivision shown in FIG. 4, but allows variable subdivision of the image format 20 into the individual partial image formats according to the requirements to be met by the display assembly 10.

1-15. (canceled)

16. A display assembly, comprising:
a screen having a plurality of individual screen modules; and
control electronics adapted to energize the screen modules;
wherein the control electronics:
are configured to:
process an incoming image format, corresponding to a reproduction on the screen, to produce a plurality of individual partial image formats, corresponding to a reproduction on the individual screen modules; and
transmit the partial image formats to the corresponding screen modules;
are separate from the screen modules and comprise programmable logic IC components; and
further comprise:
an input for receiving the incoming image format from an input source; and
a plurality of outputs connected to the corresponding screen modules and adapted to transmit the partial image formats to the corresponding screen modules in parallel.

17. The assembly according to claim 16, wherein the programmable logic IC components comprise at least one of a field programmable gate array (FPGA), a complex programmable logic device (CPLD), or system-on-a-chip (SoC) technology.

18. The assembly according to claim 16, wherein the control electronics are configured to execute instructions in a hardware description language (HDL).

19. The assembly according to claim 18, wherein the hardware description language comprises at least one of a very high speed integrated circuit hardware description language (VHDL) or a Verilog language.

20. The assembly according to claim 16, wherein the programmable logic IC components comprise integrated circuits having a logic complexity between 1,200 and 2,000,000 gate equivalents.

21. The assembly according to claim 20, wherein the programmable logic IC components comprise integrated circuits having a logic complexity between 1,200 and 150,000 gate equivalents, and the incoming image format has a resolution of no more than 1920×1200 pixels.

22. The assembly according to claim 16, wherein:
the control electronics are further configured to digitally transmit a partial image format to a screen module; and
the partial image formats include individual pixels represented as at least one of 18-, 24- or 30-bit data words.

23. The assembly according to claim 16, further comprising at least one of a low voltage differential signaling (LVDS) interface or a transistor-transistor logic (TTL) interface;
wherein:
the LVDS interface or TTL interface is configured to transmit the partial image formats to the individual screen modules, and
the LVDS interface is configured to transmit the partial image formats over distances exceeding 1 meter.

24. The assembly according to claim 16, wherein at least one screen module comprises at least one of a thin-film transistor (TFT) display, an organic light emitting diode (OLED) display, or an active matrix OLED (AMOLED) display.

25. The assembly according to claim 24, wherein at least one screen module has a resolution of no more than 1024×600 pixels.

26. The assembly according to claim 25, wherein at least one screen module has a resolution of at least one of 320×240, 400×240, 480×272, 480×320, 640×480, 800×480, 800×600, or 1024×600 pixels.

27. The assembly according to claim 16, wherein the incoming image format has a variable resolution.

28. The assembly according to claim 16, wherein the incoming image format has a fixed resolution.

29. The assembly according to claim 28, wherein the incoming image format has a resolution of no more than 1920×1200 pixels.

30. The assembly according to claim 16, wherein the control electronics further comprise an image memory, and the image memory is configured to operate in at least one of double-buffering mode or triple-buffering mode.

31. A product information or advertising device comprising the assembly according to claim 16.

32. The assembly according to claim 16, wherein at least one of the screen modules comprises an interactive display.

33. A method for operating a display assembly, comprising:
receiving an incoming image format;
processing the incoming image format to obtain a plurality of individual partial image formats using programmable logic IC components; and
transmitting the individual partial image formats to a screen included in the display assembly,
wherein the input image format comprises a digital video signal, and
the individual partial image formats correspond to a reproduction on a plurality of individual screen modules included in the screen.

34. A method for displaying an image format on a display assembly, comprising:
receiving an incoming image format;
processing the incoming image format to obtain a plurality of individual partial image formats using programmable logic IC components;
transmitting the individual partial image formats to a screen included in the display assembly; and
displaying reproductions of the individual partial image formats on a plurality of individual screen modules included in the screen,
wherein the input image format comprises a digital video signal, and
at least two of the partial image formats are transmitted in parallel.

35. A method for generating an image format, comprising:
receiving a digital video signal; and
converting the digital video signal into an image format,
wherein the image format has a resolution selected to correspond to a total native resolution of a screen which comprises a plurality of individual screen modules,
the image format has individual pixels represented as at least one of 18-, 24- or 30-bit data words, and
the image format is adapted for subdivision into a plurality of partial image formats.
